(19) United States
(12) Patent Application Publication
(10) Pub. No.: US 2009/0297672 A1
(43) Pub. Date: Dec. 3, 2009

(54) Process for improving shelf life of refrigerated foods

(76) Inventor: Darian Warne, Victoria (AU)

Correspondence Address: MORGAN LEWIS & BOCKIUS LLP, 1111 PENNSYLVANIA AVENUE NW, WASHINGTON, DC, 20004, US

(21) Appl. No.: 11/922,147

(22) PCT Filed: Jun. 13, 2006
(86) PCT No.: PCT/AU06/00812

§ 371 Date: Jun. 22, 2009

(30) Foreign Application Priority Data
Jun. 14, 2005 (AU) 2005903090

(51) Int. Cl. A23L 3/10

(52) U.S. Cl. 426/106; 426/392; 426/412; 426/407

(57) ABSTRACT

A process for producing a food product having an extended refrigerated shelf life comprising sealing food in a container; heating the food in the sealed container at a desired temperature for a desired period to inactivate undesirable microorganisms likely to be present in the food; rapidly cooling the heated food to substantially prevent germination of undesirable microbial spores likely to be present in the food; wherein undesirable microorganisms present in the food are substantially inactivated and other microorganisms are prevented from re-contaminating the food after processing so that the food product has an extended refrigerated shelf life.

### TECHNICAL FIELD

The present invention relates to food processing resulting in extended shelf life of refrigerated processed food products.

### BACKGROUND ART

The health risks associated with under-processing spoilage of shelf-stable low-acid canned foods most frequently relate to the survival of proteolytic Clostridium botulinum spores. In contrast, with refrigerator stable minimally processed low-acid foods, the focus of attention frequently (but not exclusively) becomes survival and growth of the more heat sensitive non-proteolytic C. botulinum spores and also Bacillus cereus spores. With shelf-stable canned foods, the aim of the thermal process is to reduce the probability of survival of a single C. botulinum spore by a factor of a million million (Hersom, A. C. and Hulland, E. D. (1980). Canned Foods. 7^{th} Edition. Churchill Livingstone, London, pp. 118-181). This means that the probability that one spore of proteolytic C. botulinum will survive the thermal process is one in 10¹². This approach has given rise to the so-called 12D concept (Stumbo, C. R. (1973). Thermobacterlology in Food Processing. 2^{nd} Edition. Academic Press: New York) which, conservatively, assumes an initial contamination level of one spore/g of product located at the slowest heating point (SHP) of the container. Strictly speaking, the probability of C. botulinum spore survival in the container at points other than the SHP will be less than one in 10¹². However, irrespective of whether consideration is for the entire container or a single gram of product at the SHP, there is little practical distinction between the two viewpoints in terms of risks to consumer health.

The prevention of under-processing spoilage by pathogens other than mesophilic C. botulinum has not been considered an issue when designing thermal processes for low-acid shelf-stable foods. The reason for this is that the minimum process must achieve, at least, a 12-logarithmic reduction in survivors specifically for mesophilic C. botulinum, which has a D_{121.1} value of 0.23 min (Hazzard, A. W. and Murrell, W. G. (1989). Clostridium botulinum. In Buckle, K. A. et al. (eds). Foodborne microorganisms of public health significance. 4^{th} Edition. AIFST, Sydney, Australia, pp. 179-208) and which is considered the most heat resistant pathogen likely to be found in foods. This means that a so-called 12D process also will be sufficient to bring about satisfactory reduction in the probability of survival of other less heat resistant pathogens. Therefore, the only circumstances in which other pathogenic microorganisms may lead to under-processing spoilage in low-acid canned foods would be when there had been gross under-processing, such as might occur had the product not been retorted.

With refrigerator-stable low-acid foods, also known as refrigerated pasteurised foods of extended durability or REPFEDs, current thermal processes are based on destruction of target microorganisms different to those in shelf-stable foods. As noted above, this typically includes targeting spore-forming non-proteolytic C. botulinum. In addition, the non-spore-forming Listeria monocytogenes and/or the spore-forming Bacillus cereus may also need to be considered. Typically for REPFEDs, Good Manufacturing Practice (GMP) requires that the thermal process will be at least equivalent to a 6D process (i.e. a reduction by a factor of 10⁶) for the target microorganism. Hence, it was with respect to the thermal destruction of non-proteolytic Clostridium botulinum that the Advisory Committee on the Microbiological Safety of Food (ACMSF, 1992), Betts (1996), the European Chilled Foods Federation (ECFF, 1996) and the Australian Quarantine and Inspection Service (AQIS, 1992) all issued guidelines recommending that the minimum thermal processes should at least be equivalent to 10 min at 90° C. This “guideline” heat treatment was based on research by Gaze and Brown (1990) at the Campden Food and Drink Association that was quoted by the Advisory Committee on the Microbiological Safety of Food (ACMSF, 1992). Gaze and Brown (1991) found that the D₉₀ value for non-proteolytic Clostridium botulinum was 1.1 min, so that a 6D process would be equivalent to 7 (6.6) min at 90° C. However, in order to incorporate a safety margin ACMSF (1992) recommended that the 6D process for psychrotrophic Clostridium botulinum should be equivalent to 10 min at 90° C. The inclusion of the “safety margin” therefore implied the possibility of an actual D₉₀ value for non-proteolytic Clostridium botulinum of 1.7 min at 90° C.

A thermal process equivalent to 10 min at 90° C. will be more than sufficient to bring about the required degree of destruction for L. monocytogenes which does not form spores and which has a relatively low D₇₀ value of less than 0.3 min in various media including chicken, beef, carrot and reconstituted dried milks El-Shenawy, M. A., Yousef, A. E. and Marth, E. H. (1989). Thermal inactivation and injury of Listeria monocytogenes in reconstituted non fat dry milk. Milchwissen 44(12): 741-5; Mackey, B. M., Pritchet, C., Norris, A. and Mead, G. C. (1990). Heat resistance of Listeria: strain differences and effects of meat type and curing salts. Letters in Applied Microbiology 109: 251-5; Gaze, J. E., Brown, G. D., Gaskell, D. E. and Banks, J. G. (1989). Heat resistance of Listeria monocytogenes in homogenates of chicken, beef steak and carrot. Food Microbiology 6: 153-6, and Boyle, D. L., Sofos, J. N. and Schmidt, G. R. (1990). Thermal destruction of Listeria monocytogenes in a meat slurry and in ground beef. Journal of Food Science 55(2): 327-9.

Food safety risks with REPFEDs in hermetically sealed containers are not confined to those arising as a result of survival of Listeria monocytogenes or non-proteolytic C. botulinum because of under-processing, or the growth of proteolytic C. botulinum because of poor control of chilled temperatures. It is accepted that spores of the latter will not have suffered any significant destruction at the processing temperatures and processing times typically used in minimal processing. Food safety risks also arise because Bacillus cereus spores which can be more heat resistant than those of non-proteolytic C. botulinum. Consequently, Bacillus cereus spores also should be considered as potential pathogenic survivors of minimal processes that have been designed solely to be equivalent to the Good Manufacturing Practice guideline of 10 min at 90° C.

Despite the food safety risks described above, processes equivalent to 10 min at 90° C. have come to be regarded as the benchmark for REPFEDs in which the storage temperature shall be below the minimum required for growth of proteolytic C. botulinum. While the severity of the heat treatment in these processes is quantified (e.g. 10 min at 90° C., or its equivalent), the meaning of the phrase “extended durability” is less precise. For instance, although ACMSF (1992) and ECFF (1996) each differentiate between shelf-lives of less than 10 days and more than 10 days, neither specifies an upper limit to shelf life. As a guide to commercial practice in Australia, use-by dates of six to 10 weeks from the date of production are likely to be the maximum recommended for refrigerated storage at ≦4° C. Some manufacturers of REPFEDs find that an upper limit of 10 weeks refrigerated shelf life is insufficient for distribution and storage of their value-added perishable products, particularly when these are destined for export markets. Examples of products falling into this category include whole abalone, whole-shell mussels, whole salmon and salmon portions, infant foods, soups, sauces, ready meals, pet foods and selected cheeses.

The present inventor has now developed a process for heat treating and cooling packaged foods to significantly prolong their refrigerated shelf life and to improve their quality during extended storage. In addition, the technology involves the use of microbiological and thermal process modelling procedures for quantifying the food safety risks arising from survival, outgrowth and multiplication of target spore-forming bacteria at refrigeration temperatures and at “abuse” temperatures, and post-process leaker contamination.

### DISCLOSURE OF INVENTION

In a first aspect, the present invention provides a process for producing a food product having an extended refrigerated shelf life comprising:

sealing the food in a container;

heating the food in the sealed container at a desired temperature for a desired period to inactivate undesirable microorganisms likely to be present in the food; and

rapidly cooling the heated food to substantially prevent germination of undesirable microbial spores likely to be present in the food;

wherein undesirable microorganisms present in the food are substantially inactivated and other microorganisms are prevented from re-contaminating the food after processing so that the food product has an extended refrigerated shelf life.

In the second aspect, the present invention provides a process for obtaining a processed refrigerated food product comprising:

placing food material in a container;

hermetically sealing the container;

heating the food material in the sealed container at a desired temperature for a desired period to inactivate undesirable microorganisms likely to be present in the food material; and

rapidly cooling the heated food to substantially prevent germination of undesirable microbial spores likely to be present in the food material to obtain a processed food product having a refrigerated shelf life of at least three months.

Preferably, the food material is selected from most foods types that require heating and/or cooking prior to their consumption. Examples include, but are not limited to, ready meals, wet dishes, infant foods, fruit and vegetables, salads, sauces, soups, value added seafood including tuna, salmon or sardines, molluscs, crustacea, rice, wheat, beans, pasta, noodles, and companion animal (pet) foods.

In one preferred form, the food material is dry and requires cooking, such as such as rice, pasta, noodles and beans; or it may include fresh perishable materials which also require cooking prior to consumption such as meats, fish, molluscs, crustacea, poultry, dairy products, infant foods, soups, sauces, wet dishes and selected fruit and vegetables.

Preferably, the container is a rigid, semi-rigid or flexible container. Examples include, but not limited to metal cans, glass containers and flexible and semi-flexible containers such as plastic or aluminium tubs, cups, bowls and pouches.

The term “extended refrigerated shelf life” is used herein to be at least about three months at storage temperature of about 4° C. Preferably, the extended refrigerated shelf life is at least about six months. The refrigerated shelf life can be extended up to about 12 months using the present invention. The present invention allows at least a doubling of the refrigerated shelf life of a food product compared with the corresponding product produced by current processing technologies.

Preferably, the desired heating temperature is between about 80° C. and 110° C., Typically, the desired temperature is between about 90° C. and 100° C. It will be appreciated, however, that the desired temperature may vary depending on the starting material, the final food product, the mass of food to be processed, and the number and type of microbial contaminants and their heat resistance in the food medium. The heating step is designed to kill or inactivate undesirable microorganisms that are predicted to be present in the starting raw food ingredients but the heating does not need to be sufficient to kill all microbial spores that may be present in the starting raw food ingredients.

Preferably, the rapid cooling is at least about 2° C. per minute. More preferably, the rapid cooling is between about 3° C. to 5° C. per minute. It will be appreciated, however, that the cooling rate will vary depending on the nature and mass of the food product, the presence or absence of particulates and the dimensions and composition of the packaging material in which the product is contained.

Preferably, the rapid cooling will reduce the product temperature to about 10° C. or less. More preferably, the rapid cooling will reduce the product temperature to about 5° C. or less. It will be appreciated, however, that the cooling rate will vary depending on the nature and mass of the food product, the presence or absence of particulates and the dimensions and composition of the packaging material in which the product is contained. After rapid cooling, the product is typically stored, held or refrigerated at about 4° C.

Preferably the cooling is carried out using a combination of cooling water at ambient temperatures, chilled water and/or liquid nitrogen or carbon-dioxide which are used as direct contact refrigerants. The transit time (when the product cools from its maximum temperature to its final core temperature) is product and pack specific and can be monitored and specified after heat penetration trials. Typically, the transit time is chosen to ensure there is insufficient time to allow germination and outgrowth of the mesophilic and thermophilic spore formers which are predicted to be present in the starting raw food ingredients and which could survive the heat treatment step. A rapid cooling sequence also minimises overcooking and associated quality losses and yield losses (cook out).

The rapid cooling step can prevent both mesophilic and thermophilic microbial spores from germinating.

The heating can be carried out using over- or positive pressure in a suitable vessel or retort.

The present inventor has found that cryogenic cooling retort is particularly suitable for the present invention. Suitable cryogenic cooling apparatus for the present invention is produced by Lagarde Autoclaves, France.

The present invention is particularly suitable for food processing industries such as manufacturers of heat processed package foods supplying retail markets, institutions, the food service sector and caterers.

The type and characteristics of the potential microbial load of the starting material is preferably determined by the quality and type of the raw food material. It should be noted, however, that this is not likely to impose restrictions on the use of the technology provided that the unprocessed product can be considered typical of commercial quality and fit for the purpose intended.

The food is filled or placed into containers prior to heat treatment. After filling, the containers are typically hermetically sealed to prevent entry of microbial contaminants during and after processing.

The starting food may be filled and sealed at chilled, ambient or elevated temperatures after which it is placed in the processing vessel (e.g. a retort or pasteurising system) for heat treating at between about 80° C. and 110° C. for between about 1 and 90 minutes, preferably between about 5 and 60 minutes more preferably between about 15 and 40 minutes. For example, the food can be heated to about 95° C. to 105° C. for up to 30 to 40 minutes in an over-pressure retort it will be appreciated, however, that the heating temperature and duration of heating will vary depending on the nature of the heating medium, the arrangement of the packaged food in the processing vessel and the food type and its mass and thermal diffusivity and nature and geometry of the packaging material that is used.

The heated food is cooled rapidly at a rate in the range of about 2° C. per minute or more. More preferably, the heated food is cooled rapidly at a rate of about 3 to about 5° C. minute. It will be appreciated, however, that the rate of cooling will vary depending on the nature of the cooling medium, the arrangement of the packaged food in the processing vessel and the food type, and its mass and thermal diffusivity and the nature and geometry of the packaging material that is used.

The present invention can result in the extension of the shelf life at below about 4° C. of foods such as heat treated rice, pasta, noodles and beans; fresh perishable materials including meats, fish, molluscs, crustacean, poultry, dairy products, infant foods, soups, sauces wet dishes (i.e. ready meals), companion animal (pet) foods and selected fruit and vegetables, to about one year or more depending on the packaging material that is selected. Once heat treated and cooled the product packaged in its hermetically sealed container is microbiologically stable whilst held at refrigeration temperatures.

Preferably, the processes according to the present invention can deliver up to 12-log, or more, reductions (depending on their heat resistance) in the microbial load of the various target microorganisms that may contaminate the food ingredients used in a food product.

In a third aspect, the present invention provides a food product having an extended refrigerated shelf life produced by the process according to the first or second aspects of the present invention.

In a fourth aspect, the present invention provides a method for developing a food processing regime for a food product having an extended refrigerated shelf life comprising:

(a) determining the type and heat resistance of potential microbial load in a food ingredient for a food product;
(b) devising a heating and cooling process for the food product based on the microbial information obtained on the food ingredient in step (a) to Inactivate undesirable microorganisms likely to be present in the food ingredient and to reduce the probabilities of survival of the microorganisms in a processed food product.

Not only does the present invention provide extended shelf life, it also allows the production of food products having desired organoleptic characteristics and qualities of comparable foods not having an extended shelf life. By determining the potential microbial presence and load of food material, it is possible to devise a suitable processing regime (heating and cooling) that not only removes undesirable microorganisms, it also allows the use of potentially less harsh processing conditions that can result in a better quality of food product, minimises loss during processing, and provides a superior product with the added advantage of having a long refrigerated shelf life.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia prior to development of the present invention.

In order that the present invention may be more clearly understood, preferred embodiments will be described with reference to the following examples.

### MODE(S) FOR CARRYINQ OUT THE INVENTION

It has now been found by the present inventor that through use of controlled heating and cooling profiles, processes sufficient to deliver up to, and more than, 12-log reductions (rather than the recommended 6-log reductions) in the probability of survival of non-proteolytic C. botulinum can be adopted and, so-called, “as fresh” quality can be maintained. The benefit of using a 12D cycle with respect to non-proteolytic C. botulinum, rather than the conventional 6D cycle, is that the thermal process is analogous to that for its shelf-stable counterpart (i.e. proteolytic C. botulinum). At probabilities of survival of non-proteolytic and proteolytic C. botulinum of ≦1 in 10¹², refrigerator stable and shelf-stable of products, respectively, can be regarded as being “commercially sterile”, provided the storage temperature of the former is at less than 10° C. and the latter is less than approximately 45° C. (to preclude germination and growth of thermophilic spore-formers that may have survived the thermal process). Under these circumstances, the limit to the shelf life of refrigerator-stable products is no longer dictated by the risk of growth of non-proteolytic C. botulinum. Rather, the determinant of shelf life is more likely to be a reflection of the prevalence and heat resistance of B. cereus spores that may contaminate the raw materials and the sensitivity of the product to quality changes during prolonged refrigerated storage. In many instances, the latter is affected by the vacuum in the container (and therefore the oxygen content) at the time of sealing and/or the oxygen permeability of the packaging material.

The pathogenic spore-former B. cereus is widely distributed in nature (ICMSF. 1996. Microorganisms in Foods 5. Characteristics of Microbial Pathogens.) which is why it is considered a possible contaminant in refrigerator-stable foods when the formulations include milk, rice, cereal products, vegetables, herbs, spices and other dried products. However, “its presence and incidence in/on fish is not well established” (ICMSF, 1996). This means that the thermal processes given refrigerator-stable foods also may need to cope with the destruction of spores of psychrotrophic B. cereus that are more heat resistant than those of non-proteolytic C. botulinum. For instance, it has been shown that at a pH of 6.5 and an a_{w} of 1.00, in a citrate/phosphate buffer B. cereus spores exhibited D values of 0.15, 2.39 and 63.39 min at temperatures of 105° C., 95° C. and 85° C., respectively. For comparative purposes, it is known that a conservative (i.e. safe) reference D₉₀ value for non-proteolytic C. botulinum can be taken as 1.7 min at 90° C. which approximately corresponds to a D₉₅ value of 0.54 min for this microorganism. This means that B. cereus spores with a D₉₅ value of 2.39 min may have, of the order of, four or more (i.e. 2.39/0.54 or 4.4) times the heat resistance of non-proteolytic C. botulinum spores. Therefore, it follows that a thermal process designed to target spores of B. cereus will need to be significantly more severe than one designed to bring about a comparable reduction in the population of non-proteolytic C. botulinum spores. For instance with respect to non-proteolytic C. botulinum, these data show that a 12D process (i.e. equivalent to 20 min at 90° C.) will bring about only 2 to 3 log reductions in the survivors of B. cereus spores; whereas the 6D process (i.e. equivalent to 10 min at 90° C.) for REPFEDs which is recommended by ACMSF, (1992), AQIS (1992), Betts (1996), ECFF (1996) and FAIR Concerted Action (1999) will achieve little more than a single log reduction in the spore counts of B. cereus.

In relation to the safety of REPFEDs, various authors (Carlin et al., 2000; ICMSF, 1996, and Tatini 2000 IFT Annual Meeting, Dallas, Tex.) have noted that heat resistance, spore germination and the ability to produce toxin are all decreased at refrigeration temperatures. Carlin et al (2000) quote a range of D₉₀ values for B. cereus spores ranging from 0.8 to 1.5, 0.8 to 3.2 and 0.9 to 5.9 min for isolates with minimum growth temperatures of <5° C., 5 to 10° C., and >10° C., respectively. Extrapolation of these data highlights the importance of refrigeration temperatures for refrigerator stable foods. For Instance, in cases where storage temperatures were between 5° C. and 10° C., a process sufficient to effect a 6D reduction in B. cereus spores would need to be equivalent to 19.2 (6×3.2) min at 90° C. However, if it were possible to maintain temperatures at less than 5° C., a process equivalent to 9 (6×1.5) min at 90° C. would suffice. This means that a 6D process that targets non-proteolytic C. botulinum (for which the target Fₚ=10 min) may also be appropriate for one targeting B. cereus (target Fₚ=9 min). It is for this reason that, when reviewing thermal processes for refrigerator stable foods in which B. cereus spores may be present, Carlin et al (2000) carried out a microbial risk assessment which included hazard Identification and characterisation, exposure assessment and challenge testing in various food systems. Studies such as these are regarded as a pivotal component of R&D programmes leading to the commercial manufacture and release of refrigerator stable foods. One of the objectives of these exercises is to determine whether spores that might survive the thermal process are capable of germination in vivo and thereafter whether cell growth and toxin production can occur under the projected storage conditions. However, cell growth alone does not necessarily represent a health risk for as noted by Gorris and Peck (1998) “high numbers of cells of Bacillus cereus are needed to pose a genuine safety hazard”.

The rationale behind the development of processing technology according to the present invention was to deliver a product in which the refrigerated shelf life exceeded the six to 10 weeks that is frequently quoted for REPFED products. The reason for seeking a shelf life extension (for up to one year in some cases) was to enable manufacturers to supply their value-added products to local and export markets that would otherwise be unavailable because of expiry of the shelf life while the product moved through the distribution and storage chains.

The REPFEDs that are produced using the processing technology according to the present invention have an extended shelf life at between 3° C. and less than 10° C. (although the labels recommend storage at ≦4° C.). This means that some products are likely to be stored at above the minimum growth temperature for non-proteolytic C. botulinum (i.e. 3° C.) and below the minimum growth temperature for proteolytic C. botulinum (i.e. 10° C.). However, as the thermal processes that are described in this invention have Fₚ values ≦20 min non-proteolytic C. botulinum spores would have received at least a 12 D cycle, after which they can be considered to have been eliminated.

Therefore delivery of 12D cycles, or Fₚ values of 20 min, for REPFEDs (as described in this invention), in preference to application of the generally recommended 6D cycles, is equivalent in sterilising effect (for non-proteolytic C. botulinum) to the Fₒ values ≦2.8 min that are used throughout the food industry to eliminated proteolytic C. botulinum in shelf-stable low-acid canned foods. Therefore the two processes have parity with respect to elimination of food safety hazards arising from survival of C. botulinum.

As a guide as to what is achievable, the present invention has been trialled with a variety of food products including abalone, mussels, companion animal (pet) foods, sauces, soups and ready meals and salmon and in some cases this has resulted in regulatory approval for production and export of items for which a refrigerated shelf life of one year is declared, provided that several additional components forming part of the technology are satisfied. Additional components which can be used as part of an integrated total processing system include one or more of the following:
I. microbial risk assessment incorporating hazard identification and characterisation, exposure assessment and challenge testing in the finished products
II. accelerated cooling using liquid nitrogen or carbon-dioxide as the cooling medium
III. microbiological challenge studies in finished products to demonstrate freedom from, or absence of growth of, psychrotrophic pathogens
IV. Biotests in which the hermetically sealed processed containers are immersed in high concentrations of bacterial cultures that induce post-process leaker contamination
V. temperature abuse studies
VI. through application of an appropriate food safety plan, implementation of monitoring and control procedures at all critical control points throughout the process

### Features

Traditionally processed chilled packaged foods are unsuitable for prolonged storage (extended shelf-lives) for a number of reasons. The thermal treatments are insufficient to eliminate, or reduce to acceptable levels, the probability of survival of target microorganisms. In these cases, because the filling and processing temperatures are low (typically ≦90° C.), the thermal processes are insufficient to enable shelf-lives beyond six to seven weeks, and often the shelf-lives are less.

In order to attempt to extend shelf lives of their chilled products some manufacturers choose to over-process (i.e. the processes are too long and/or at too high temperatures). Over processing increases the likelihood of degrading product quality and therefore the products present “as processed” rather than “as fresh. In extreme cases, to counteract the shortcomings in refrigerated shelf life, manufacturers will choose to process so that their products are shelf-stable even though they market them through the chilled chains. This means their products are presented as though they are chilled or perishable or “as fresh” even though they are shelf-stable and lack the sensory quality which is typically associated with “as fresh” items.

Failure to provide and monitor hermetic seals heightens the risks of post-processing leaker contamination (PPLC) and this is unacceptable for low-acid products with extended shelf lives. In this regard the chilled food sector fails to match the attention given by low-acid canned food manufacturers to the formation and protection of hermetic seals. Consequently, many commercially manufactured REPFEDs are at risk of post-processing leaker contamination by psychrotrophic microorganisms (some of which are pathogenic). This is one, but not the only, reason why the shelf life of these products has been restricted. The rationale adopted by these manufacturers has been restrict the time allowed for those contaminants entering the pack through PPLC to grow and therefore risk public health. As has been noted, another reason why the shelf life of traditionally prepared refrigerated foods is limited is that the thermal processes for these products are insufficient to eliminate all potential spoilers.

### Approach

Because of Inadequate knowledge of the nature, numbers and heat resistance (D values) of target microorganisms the present invention enumerates and determines the heat resistant of those microorganisms that are known (and are likely) to be present in raw materials. Once the D values of the contaminants are determined, it is possible to develop thermal processes for a particular food type which reduce their numbers to acceptable levels so that the products are safe and microbiologically stable at refrigeration temperatures. Traditional heat treatments for refrigerated foods lack this specificity i.e. they are too short, or too severe. Hence many products are either under-processed and not safe throughout the proposed shelf life, or they are over-processed and of poor quality.

Therefore, one of the preferred components providing impetus for the development of the present invention has been to seek to address the shortcomings of a lack of product safety, lack of shelf life, and poor product quality. Prior to the present invention, manufacturers have been faced with the mutually exclusive options:
I. they could achieve safety—but it was only at the expense of product quality (i.e. the products were over-processed);
II. they could achieve safety—provided the shelf life was short.
III. they could achieve quality but the shelf life was short.

The present invention aims to respond to all three options by:
I. delivering safety by achieving quantifiable Food Safety Objectives that relate to the characteristics of the target microorganisms and GMP;
II. delivering an extended refrigerated shelf life; and
III. delivering products in which sensory quality is comparable with that achieved with fresh or “as fresh” produce.

These outcomes would not be possible without obtaining knowledge of the microbiological status of the raw materials, and the heat resistance and growth characteristics of the contaminants following thermal processing while held under normal and abuse conditions during distribution and storage.

In order to ensure product safety throughout an extended refrigerated shelf life, the present invention incorporates rapid cooling, preferably using chilled water and/or liquid nitrogen or carbon-dioxide. The transit time (when the product cools from its maximum temperature to its final core temperature) is product and pack specific and is monitored and specified after heat penetration trials. Typically, the transit time is chosen ensure there is insufficient time to allow germination and outgrowth of the mesophilic and thermophilic spore formers which must be assumed to be present in the raw materials and which will survive the minimal thermal processes that are delivered. A rapid cooling sequence also minimises overcooking and associated quality losses and yield losses (cook out).

The adequacy of hermetic seals can be demonstrated by conducting challenge tests (Biotests) on containers following sealing and thermal processing and the rapid cooling regimes that shall be established under commercial operating conditions. Manufacturers typically do not microbiologically challenge the heat seals on their refrigerated products. Because of this lack of control of hermetic seals, many manufacturers are not willing to provide extended shelf-lives for their products in case post-processing leaker contamination has occurred. The present invention can place tests and put the procedures in place to monitor performance of heat sealers enable the provision of substantially unrestricted shelf-lives at ≦4° C.

The present invention delivers higher yields than with shelf-stable processes currently in use. For Instance, shelf-stable abalone in cans suffers 18 to 25% weight loss during retorting, which at a selling prices of approximately US $750/24 cans (each with a drained weight around 212 g) means the producers suffer significant loss in income. The processes of the present invention have reduced these weight losses to less than about 1%.

Compared with their shelf-stable counterparts, items manufactured using the current invention typically have superior of colour, flavour and textural after thermal processing. Products demonstrating these superior quality attributes include selected dairy items, mussels, sauces, soups, ready meals and pet foods.

Because of the shelf life that is achievable with the present invention, manufacturers would be able to target export markets from which they would otherwise be precluded.

As part of the process, challenge tests can be incorporated on finished products and is supported by predictive modelling in which the effect on shelf life of simulated abuse conditions can be established.

### Materials and Methods

### Apparatus

Trials have been completed successfully in Lagarde, Steriflow, KM and FMC over-pressure retorts operating under full load conditions. The heating and cooling schedules that are developed in the invention also may be delivered in other types of over-pressure retorts that have the capacity for rapid cooling.

### Packaging

Replicate process evaluation trials were conducted using a variety of high barrier-plastic laminated pouches and polypropylene plastic tubs, bowls and trays that had been packed with the raw material under evaluation e.g. abalone, mussels, soups, sauces, pet foods, infant foods and ready meals) each with individual pack weights and fill temperatures representing “worst-case” conditions (i.e. the heaviest net weights and/or the lowest fill temperatures of product that would be used in commercial practice). To test the process, replicate thermocouples were mounted through the sides of the pouches (or containers) into the thickest portion of the product so that their tips were located at the thermal centres (i.e. the slowest heating points or SHPs) of the individual “test” packs.

### Treatment

The method that is described below was developed for a range of products that were heat treated using a ramped temperature and ramped over-pressure cycle at between 90° C. and 105° C. and between zero and 140 kPa, respectively.

The techniques that were used for these processes and products were similar but varied according to the following:

I. Nature of the heating and cooling media
II. The arrangement of the packaged food in the processing vessel
III. The food type and its mass and thermal diffusivity
IV. The nature and geometry of the packaging material that was used

Because of the differences that have been identified (in I to IV above), the temperatures, the pressures and the processing times that were used in the various heat processing cycles were different. Typical cycles that were developed a variety of “wet” products are shown in Tables 1 to 20.

For instance in the process trials with mussels, replicate evaluations were conducted each consisting of six pouches that had been packed with 500 g mussels in a single layer and with individual mussel weights ranging from 32 to 39 g (i.e. representing “worst-case” or the heaviest net weights of individual whole mussels). Thermocouples were mounted through the sides of the pouches into the thickest portion of the raw un-opened mussel so that their tips were located at the thermal centres (i.e. the slowest heating points or SHPs) of the individual “test” packs.

The test pouches in which the thermocouples had been mounted were located on the second layer of trays while the basket was in the front position of the retort, as this had been found in the temperature distribution trials to be the preferred location of test packs for process evaluation studies. During all process evaluation trials the retort was operating under full-load conditions with the two baskets being packed with pouches that also had been filled with whole-shell mussels. In addition several thermocouples (designated as “Free”) were located adjacent to the filled pouches.

### Results

TABLE 1
Time-temperature and pressure treatment for processing whole-shell
mussels in pouches in an over-pressure retort at 90° C.

| | Duration | Temperature | Pressure |
|---|---|---|---|
| Phase | (min) | (° C.) | (kPa) |
| 1 | 7.0 | 80 | 70 |
| 2 | 4.5 | 92 | 90 |
| 3 | 3.0 | 90 | 90 |
| 4 | 50.0 | 90 | 90 |
| 5 | 3.0 | 70 | 60 |
| 6 | 3.0 | 40 | 0 |
| 7 | 15.0 | — | — |
| 8 | — | — | — |

TABLE 2
Time-temperature and pressure treatment for processing whole-shell
mussels in pouches in an over-pressure retort at 95° C.

| | Duration | Temperature | Pressure |
|---|---|---|---|
| Phase | (min) | (° C.) | (kPa) |
| 1 | 7.0 | 80 | 90 |
| 2 | 4.5 | 97 | 110 |
| 3 | 3.0 | 95 | 110 |
| 4 | 16.0 | 95 | 110 |
| 5 | 3.0 | 70 | 60 |
| 6 | 3.0 | 40 | 0 |
| 7 | 15.0 | — | — |
| 8 | — | — | — |

TABLE 3
Time-temperature and pressure treatment for whole-shell mussels in
pouches in an over-pressure retort at 101° C.

| | Duration | Temperature | Pressure |
|---|---|---|---|
| Phase | (min) | (° C.) | (kPa) |
| 1 | 7.0 | 80 | 90 |
| 2 | 4.5 | 102 | 120 |
| 3 | 3.0 | 101 | 120 |
| 4 | 5.0 | 101 | 120 |
| 5 | 3.0 | 70 | 70 |
| 6 | 3.0 | 40 | 0 |
| 7 | 15.0 | — | — |
| 8 | — | — | — |

TABLE 4
Time-temperature and pressure treatment for whole-shell mussels in
pouches in an over-pressure retort at 105° C.

| | Duration | Temperature | Pressure |
|---|---|---|---|
| Phase | (min) | (° C.) | (kPa) |
| 1 | 7.0 | 80 | 90 |
| 2 | 4.5 | 107 | 140 |
| 3 | 3.0 | 105 | 140 |
| 4 | 2.5 | 105 | 140 |
| 5 | 3.0 | 70 | 70 |
| 6 | 3.0 | 40 | 0 |
| 7 | 15.0 | — | — |
| 8 | — | — | — |

TABLE 5
Time-temperature and pressure treatment for processing in-shell
80-90 g abalone in pouches in an over-pressure retort at 90° C.

| | Time | Temperature | Pressure |
|---|---|---|---|
| Phase | (min) | (° C.) | (kPa) |
| 1 | 15 | 90 | 80 |
| 2 | 40 | 90 | 90 |
| 3 | 5 | 80 | 50 |
| 4 | 5 | 40 | 20 |
| 5 | 15 | 20 | 0 |
| 6 | 20 | — | — |

TABLE 6
Time-temperature and pressure treatment for processing in-shell
80-90 g abalone in pouches in an over-pressure retort at 95° C.

| | Time | Temperature | Pressure |
|---|---|---|---|
| Phase | (min) | (° C.) | (kPa) |
| 1 | 15 | 95 | 95 |
| 2 | 25 | 95 | 100 |
| 3 | 5 | 80 | 50 |
| 4 | 5 | 40 | 20 |
| 5 | 15 | 20 | 0 |
| 6 | 20 | — | — |

TABLE 7
Time-temperature and pressure treatment for processing in-shell
80-90 g abalone in pouches in an over-pressure retort at 100° C.

| | Time | Temperature | Pressure |
|---|---|---|---|
| Phase | (min) | (° C.) | (kPa) |
| 1 | 15 | 100 | 100 |
| 2 | 17 | 100 | 105 |
| 3 | 5 | 80 | 50 |
| 4 | 5 | 40 | 20 |
| 5 | 15 | 20 | 0 |
| 6 | 20 | — | — |

TABLE 8
Time-temperature and pressure treatment for processing in-shell
80-90 g abalone in pouches in an over-pressure retort at 105° C.

| | Time | Temperature | Pressure |
|---|---|---|---|
| Phase | (min) | (° C.) | (kPa) |
| 1 | 15 | 105 | 105 |
| 2 | 13 | 105 | 120 |
| 3 | 5 | 80 | 50 |
| 4 | 5 | 40 | 20 |
| 5 | 15 | 20 | 0 |
| 6 | 20 | — | — |

TABLE 9
Time-temperature and pressure treatment for in-shell 95-100 g
abalone in pouches in an over-pressure retort at 90° C.

| | Time | Temperature | Pressure |
|---|---|---|---|
| Phase | (min) | (° C.) | (kPa) |
| 1 | 15 | 90 | 80 |
| 2 | 38 | 90 | 90 |
| 3 | 5 | 80 | 50 |
| 4 | 5 | 40 | 20 |
| 5 | 15 | 20 | 0 |
| 6 | 20 | — | — |

TABLE 10
Time-temperature and pressure treatment for in-shell 95-100 g
abalone in pouches in an over-pressure retort at 95° C.

| | Time | Temperature | Pressure |
|---|---|---|---|
| Phase | (min) | (° C.) | (kPa) |
| 1 | 15 | 95 | 95 |
| 2 | 22 | 95 | 100 |
| 3 | 5 | 80 | 50 |
| 4 | 5 | 40 | 20 |
| 5 | 15 | 20 | 0 |
| 6 | 20 | — | — |

TABLE 11
Time-temperature and pressure treatment for in-shell 95-100 g
abalone in pouches in an over-pressure retort at 100° C.

| | Time | Temperature | Pressure |
|---|---|---|---|
| Phase | (min) | (° C.) | (kPa) |
| 1 | 15 | 100 | 100 |
| 2 | 15 | 100 | 105 |
| 3 | 5 | 80 | 50 |
| 4 | 5 | 40 | 20 |
| 5 | 15 | 20 | 0 |
| 6 | 20 | — | — |

TABLE 12
Time-temperature and pressure treatment for in-shell 95-100 g
abalone in pouches in an over-pressure retort at 105° C.

| | Time | Temperature | Pressure |
|---|---|---|---|
| Phase | (min) | (° C.) | (kPa) |
| 1 | 15 | 105 | 105 |
| 2 | 11 | 105 | 120 |
| 3 | 5 | 80 | 50 |
| 4 | 5 | 40 | 20 |
| 5 | 15 | 20 | 0 |
| 6 | 20 | — | — |

TABLE 13
Time-temperature and pressure treatment for various “wet”
products in plastic cups and pouches in an over-pressure
retort at 95° C.

| | Time | Temperature | Pressure |
|---|---|---|---|
| Phase | (min) | (° C.) | (kPa) |
| 1 | 12 | 95.0 | 100 |
| 2 | Note 1, 2, 3, 4, 5 | 95.0 | 110 |
| 3 | 3 | 70.0 | 60 |
| 4 | 5 | 40.0 | 30 |
| 5 | 20 | 25.0 | 0 |
| 6 | 15 | — | — |

1. Pumpkin and cous-cous in 200 g cup Hold time = 50 min
2. Custard in 200 g cup Hold time = 50 min
3. Chicken and corn soup in 400 g cup Hold time = 60 min
4. Cashew chilli and marsala in 100 g pouch Hold time = 46 min
5. Rice in 100 g pouch Hold time = 37 min

TABLE 14
Time-temperature and pressure treatment for various “wet” products
in plastic cups and pouches in an over-pressure retort at 101.5° C.

| | Time | Temperature | Pressure |
|---|---|---|---|
| Phase | (min) | (° C.) | (kPa) |
| 1 | 12 | 101.5 | 100 |
| 2 | Note 1, 2, 3, 4, 5 | 101.5 | 120 |
| 3 | 3 | 70.0 | 60 |
| 4 | 5 | 40.0 | 30 |
| 5 | 20 | 25.0 | 0 |
| 6 | 15 | — | — |

1. Pumpkin and cous-cous in 200 g cup Hold time = 32 min
2. Custard in 200 g cup Hold time = 32 min
3. Chicken and corn soup in 400 g cup Hold time = 43 min
4. Cashew chilli and marsala in 100 g pouch Hold time = 29 min
5. Rice in 100 g pouch Hold time = 24 min

TABLE 15
Time-temperature and pressure treatment for various “wet” products
in plastic cups and pouches in an over-pressure retort at 105° C.

| | Time | Temperature | Pressure |
|---|---|---|---|
| Phase | (min) | (° C.) | (kPa) |
| 1 | 12 | 105.0 | 105 |
| 2 | Note 1, 2, 3, 4, 5 | 105.0 | 125 |
| 3 | 3 | 70.0 | 65 |
| 4 | 5 | 40.0 | 30 |
| 5 | 20 | 25.0 | 0 |
| 6 | 15 | — | — |

1. Pumpkin and cous-cous in 200 g cup Hold time = 27 min
2. Custard in 200 g cup Hold time = 27 min
3. Chicken and corn soup in 400 g cup Hold time = 37 min
4. Cashew chilli and marsala in 100 g pouch Hold time = 24 min
5. Rice in 100 g pouch Hold time = 20 min

TABLE 16
Time-temperature and pressure treatment for various “wet” products
in plastic cups and pouches in an over-pressure retort at 110.0° C.

| | Time | Temperature | Pressure |
|---|---|---|---|
| Phase | (min) | (° C.) | (kPa) |
| 1 | 12 | 110.0 | 100 |
| 2 | Note 1, 2, 3, 4, 5 | 110.0 | 120 |
| 3 | 3 | 70.0 | 70 |
| 4 | 5 | 40.0 | 35 |
| 5 | 20 | 25.0 | 0 |
| 6 | 15 | — | — |

1. Pumpkin and cous-cous in 200 g cup Hold time = 22 min
2. Custard in 200 g cup Hold time = 22 min
3. Chicken and corn soup in 400 g cup Hold time = 31 min
4. Cashew chilli and marsala in 100 g pouch Hold time = 20 min
5. Rice in 100 g pouch Hold time = 16 min

TABLE 17
Time-temperature and pressure treatment for companion animal
(pet food) products in 80-90 g plastic cups in
an over-pressure retort at 95° C.

| | Temperature | Time | Pressure |
|---|---|---|---|
| Step | (° C.) | (min) | (kPa) |
| 1 | 70.0 | 5.0 | 30 |
| 2 | 96.0 | 10.0 | 100 |
| 3 | 96.0 | 1.0 | 100 |
| 4 | 95.0 | 1.0 | 100 |
| 5 | 95.0 | 46.0 | 100 |
| 6 | 90.0 | 2.0 | 60 |
| 7 | 60.0 | 2.0 | 30 |
| 8 | 45.0 | 5.0 | 20 |
| 9 | 40.0 | 6.0 | 10 |
| 10 | 38.0 | 5.0 | 1 |

TABLE 18
Time-temperature and pressure treatment for companion animal
(pet food) products in 80-90 g plastic cups in an
over-pressure retort at 100° C.

| | Temperature | Time | Pressure |
|---|---|---|---|
| Step | (° C.) | (min) | (kPa) |
| 1 | 70.0 | 5.0 | 30 |
| 2 | 101.0 | 10.0 | 105 |
| 3 | 101.0 | 1.0 | 105 |
| 4 | 100.0 | 1.0 | 105 |
| 5 | 100.0 | 25.0 | 105 |
| 6 | 90.0 | 2.0 | 70 |
| 7 | 60.0 | 2.0 | 40 |
| 8 | 45.0 | 5.0 | 20 |
| 9 | 40.0 | 6.0 | 10 |
| 10 | 38.0 | 5.0 | 1 |

TABLE 19
Time-temperature and pressure treatment for companion animal
(pet food) products in 80-90 g plastic cups in
an over-pressure retort at 105° C.

| | Temperature | Time | Pressure |
|---|---|---|---|
| Step | (° C.) | (min) | (kPa) |
| 1 | 70.0 | 5.0 | 30 |
| 2 | 106.0 | 10.0 | 110 |
| 3 | 106.0 | 1.0 | 110 |
| 4 | 105.0 | 1.0 | 110 |
| 5 | 105.0 | 16.0 | 110 |
| 6 | 90.0 | 2.0 | 70 |
| 7 | 60.0 | 2.0 | 40 |
| 8 | 45.0 | 5.0 | 20 |
| 9 | 40.0 | 6.0 | 10 |
| 10 | 38.0 | 5.0 | 1 |

TABLE 20
Time-temperature and pressure treatment for companion animal
(pet food) products in 80-90 g plastic cups in
an over-pressure retort at 110° C.

| | Temperature | Time | Pressure |
|---|---|---|---|
| Step | (° C.) | (min) | (kPa) |
| 1 | 70.0 | 5.0 | 30 |
| 2 | 111.0 | 10.0 | 120 |
| 3 | 111.0 | 1.0 | 120 |
| 4 | 110.0 | 1.0 | 120 |
| 5 | 110.0 | 11.0 | 120 |
| 6 | 90.0 | 2.0 | 80 |
| 7 | 60.0 | 2.0 | 50 |
| 8 | 45.0 | 5.0 | 20 |
| 9 | 40.0 | 6.0 | 10 |
| 10 | 38.0 | 5.0 | 1 |

In summary, the data from the trials using the process schedules shown in Tables 1 to 20, confirm that the ramped time-temperature combinations selected were all sufficient to deliver minimum Fₚ values of greater than 20 min for mussels and between 30 and 100 min for the other products that have been produced using the technology. These data indicate that in all cases the processes were equal to or greater than 12D cycles for non-proteolytic Clostridium botulinum, which means that they are at least twice those recommended by various Good Manufacturing Practice guidelines for these categories of foods.

These processes were also more than sufficient to satisfy product safety concerns in products in which B. cereus spores may be present. With respect to B. cereus spores with maximum D₉₀ values of 3.2 min (Carlin et al, 2000), the processes described in Tables 1 to 20, will deliver between 6D and >30D cycles. Whereas for B. cereus spores with maximum D₉₀ values of 6 min (Carlin et at, 2000), the processes described in Tables 1 to 20, will deliver between 3D and >15D cycles.

It is the ability of the invention to deliver thermal processes that are more severe than those recommended with conventional heat treatments for refrigerated foods (while maintaining “as fresh” characteristics) that enables the refrigerated shelf life of these products to be extended beyond those which were previously achievable.

It will be appreciated that the technology that has been developed and demonstrated in the trials described herein will be applicable to a range of products including rice, pasta, noodles and beans, as well as fresh perishable materials such as meats, fish, molluscs, crustacean, poultry, dairy products, infant foods, soups, sauces wet dishes (i.e. ready meals), companion animal (pet) foods and selected fruit and vegetables

Pet Food

| Ingredient | Proportion of batch (%) |
|---|---|
| Chicken Frames (Minced) | 50.0 |
| Diced Beef | 30.0 |
| Water | 14.7 |
| Cereal Protein | 2.0 |
| Carrageenan (kappa) | 1.8 |
| Potassium Chloride | 0.10 |
| Vitamin Mineral Premix | 1.1 |
| Colour | 0.30 |

### Procedure:

I. Mince chicken frames (3 mm)

II. Dice beef (10 mm-15 mm)

III. Add chicken and beef to steam-jacketed mixer

IV. Add water

V. Add remaining ingredients

VI. Begin mixing

VII. After 5 minutes turn on steam

VIII. Heat to 85° C.

IX. Fill and Seal

X. Heat process and cool

XI. Store chilled at ≦4° C.

Chicken and Corn Soup

| Ingredient | Proportion of batch (%) |
|---|---|
| Water | 41.8 |
| Sweet Corn Puree | 24.0 |
| Potatoes | 10.0 |
| Chicken Stock | 6.0 |
| Chicken | 6.0 |
| Onions | 3.0 |
| Potato Starch | 3.0 |
| Modified Starch | 1.8 |
| Sugar | 1.5 |
| Salt | 1.3 |
| Hydrolysed Vegetable | 1.0 |
| Protein | |
| Chives | 0.3 |
| Xanthan Gum | 0.2 |
| Ribonucleotides | 0.1 |

### Procedure:

I. Blend xanthan gum with sugar

II. Add water to steam-jacketed vat

III. Begin mixer

IV. Add potatoes, corn, chicken stock, chicken, onions

V. Turn on steam

VI. Add remaining ingredients

VII. Add sugar/xanthan gum mixture

VIII. Continue heating until the mix reaches 92° C.

IX. Hold at 75° C. minimum

X. Fill and seal

XI. Heat process and cool

XII. Store chilled at ≦4° C.

Pumpkin and Cous Cous

| Ingredient | Proportion of batch (%) |
|---|---|
| Water | 21.5 |
| Pumpkin Puree | 60.0 |
| Cous Cous | 10.0 |
| Butter | 3.0 |
| Modified Starch | 1.30 |
| Sugar | 1.50 |
| Salt | 1.20 |
| Flavour | 0.80 |
| Spices | 0.50 |
| Xanthan Gum | 0.20 |

### Procedure

I. Add water and cous cous to steam jacketed mixer.

II. Heat to 60° C. Allow to stand for 10 minutes to prehydrate cous cous.

III. Blend xanthan with sugar

IV. Add pumpkin puree to mixing vat

V. Add butter and remaining ingredients

VI. Heat to 92° C.

VII. Store at >65° C.

VIII. Fill and seal

IX. Heat process and cool

X. Store chilled at ≦4° C.

Custard

| Ingredient | Proportion of batch (%) |
|---|---|
| Full Cream Milk Powder | 11.6 |
| Water | 77.27 |
| Sugar | 7.30 |
| Modified Starch (1422) | 2.10 |
| Flavour | 1.00 |
| Vegetable Gums | 0.40 |
| (carrageenan, xanthan) | |
| Colours | 0.20 |
| Salt | 0.13 |

### Procedure

I. Blend gums with sugar

II. Add water to steam-jacketed vat

III. Begin mixer

IV. Add sugar and gums

V. Mix for 2 minutes

VI. Add remaining ingredients

VII. Heat to 92° C.

VIII. Fill and seal

IX. Heat process and cool

X. Store chilled at ≦4° C.

Cashew Chilli and Marsala

| Ingredient | Proportion of batch (%) |
|---|---|
| Water | 36.0 |
| Egg Yolk | 2.0 |
| Sunflower Oil | 12.0 |
| Spices | 5.0 |
| Mushrooms, fresh | 5.0 |
| Sugar | 3.4 |
| Salt | 1.8 |
| Cashews-Crushed | 5.0 |
| Marsala | 18 |
| Butter, Unsalted | 8.0 |
| Modified Starch | 2.4 |
| Xanthan Gum | 0.33 |
| Vinegar | 0.50 |
| Caramel Colour | 0.30 |

### Procedure:

I. Add water to steam-jacketed mixer

II. Begin high-shear mixer.

III. Slowly add egg yolk, sunflower oil, xanthan gum and softened butter

IV. Mix for 6 minutes

V. Turn off high-shear mixer

VI. Turn on stirrer

VII. Add sugar, spices, mushrooms, salt, cashews, starch and colour

VIII. Add marsala and vinegar

IX. Begin heating

X. Heat until mix is 92° C.

XI. Fill and Seal

XII. Heat process and cool

XIII. Store chilled at ≦4° C.

Rice

| Ingredient | Proportion of batch (%) |
|---|---|
| Cooked Rice | 100% |

### Procedure:

I. Add 200 kg of water to steam-jacketed mixer

II. Bring water to the boil

III. Add 50 kg of rice

IV. Heat until cooked (˜15 minutes)

V. Drain off excess water

VI. Fill and seal

VII. Heat Process and Cool

VIII. Store chilled at ≦4° C.

Table 21 shows typical contamination levels that have been identified as potential contaminants of various food ingredients.

TABLE 21
Potential microbial contamination levels in food ingredients

| | Aerobic Plate Count | Spore Count |
|---|---|---|
| Ingredient | (log₁₀ CFU/g or cm²) | (log₁₀ CFU/g or cm²) |
| Mixed spices | 6.0-8.4 | 5.8-7.9 |
| Paprika | 7.0 | 7.1 |
| Pepper, black | 8.0 | 8.1 |
| Pepper, white | 5.6 | 4.1 |
| Sugar | <2.0 | <1.0 |
| Starches | <3.0 | <1.0 |
| Beef (frozen | 2.5 | <1 (est.) |
| boneless) | | |
| Lamb (frozen | 3.3 | <1 (est.) |
| boneless) | | |
| Pork (chilled | 2.5 | <1 (est.) |
| carcasses) | | |
| Poultry (chilled | 3.8 | <1 (est.) |
| birds) | | |
| Fish (frozen) | 3-5 (est.) | <1 (est.) |
| Vegetables | 3.6-7.5 | <3-4 (est.) |
| (unprocessed) | | |

Table 22 shows typical shelf-life of refrigerated foods that have been produced by the present invention and, for comparative purposes, the shelf-life of similar foods using the prior art methods that are on the market.

TABLE 22
Typical shelf-life of refrigerated foods

| | Current | | |
|---|---|---|---|
| Food Product | process | Invention | Increase (%) |
| Pet food | ≦21 days | Up to 6 months | >700 |
| Soups | ≦42 days | Up to 9 months | >500 |
| Pumpkin and cous-cous | <42 days | Up to 6 months | >300 |
| Custard | <42 days | Up to 6 months | >300 |
| Cashew, chilli and marsala | <42 days | Up to 6 months | >300 |
| Rice | <21 days | Up to 6 months | >700 |
| Abalone | <10 days | Up to 12 months | >3,000 |
| Whole shell mussels | <10 days | Up to 12 months | >3,000 |

### SUMMARY

The technology supporting the present invention can incorporate:
I. Determination of heat resistance (D values) of target microorganisms in finished (commercial) products.
II. Development of thermal processing and rapid cooling schedules for selected low-acid and acid foods packed in hermetically sealed containers sufficient to render these products microbiologically stable when stored at ≦4° C. and to satisfy the appropriate Food Safety Objectives (FSOs) for these categories of foods.
III. Validation of thermal processes via
   Heat penetration trials
   Microbiological challenge tests
IV. Modelling growth characteristics of target microorganisms under standard and “abuse” conditions.
V. Monitoring temperature-time profiles throughout the cold-chain.
VI. Development and specification of HACCP plans covering production and distribution.
VII. Development of microbiological challenge procedures (Biotests) to monitor and control the integrity of hermetic seals on pouches, cups or trays.
VIII. Regular auditing (via electronic transfer of process data) of records generated while monitoring critical control points (CCPs) during manufacture of heat processed foods.
IX. Annual validation of performance of retorts to ensure compliance with guidelines of GMP and, as required, annual validation of new retorts used.
X. Process filing with AQIS, FSANZ, USFDA etc.
XI. Technical support and training to satisfy regulatory requirements.

The food processing technology according to the present invention can deliver heat-processed foods with extended refrigerated shelf life. The benefits of the technology include:

High quality colour, flavour and texture (due to mild heat treatment).

Products can be promoted as “fresh,” “natural,” “no preservatives”, etc.

Refrigerated shelf life exceeds the 6-8 weeks typically found with chilled products. Current applications using the present invention allows 12 months shelf life declarations (depending on the barrier properties of the packaging materials).

Shelf life enables national (and international) distribution from one manufacturing site.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. application.

1-21. (canceled)

22. A process for producing a food product having an extended refrigerated shelf life of at least six months comprising:
sealing food in a container prior to heating to inactivate undesirable microorganisms;
heating the food in the sealed container at a temperature to achieve a minimum Fₚ value equivalent to about 20 minutes at about 90° C. to inactivate undesirable microorganisms likely to be present in the food; and
rapidly cooling the heated food to substantially prevent germination of undesirable microbial spores likely to be present in the food.

23. The process according to claim 22 wherein the food product is selected from the group consisting of ready meals, wet dishes, infant foods, fruit and vegetables, salads, sauces, soups, value added seafood, molluscs, crustacea, rice, wheat, beans, pasta, noodles, and pet foods.

24. The process according to claim 22 or 23 wherein the container is a rigid, semi-rigid or flexible container.

25. The process according to claim 22 wherein the container is selected from the group consisting of metal cans, glass containers, flexible containers and semi-flexible containers.

26. The process according to claim 22 wherein the extended refrigerated shelf life is at least about six months at a storage temperature of about 4° C.

27. The process according to claim 26 wherein the extended refrigerated shelf life is at least about nine months.

28. The process according to claim 27 wherein the extended refrigerated shelf life is up to about 12 months.

29. The process according to claim 22 wherein the heating temperature is between about 80° C. and about 110° C.

30. The process according to claim 29 wherein the temperature is between about 90° C. and about 100° C.

31. The process according to claim 22 wherein the heating is carried out from between about 1 and about 90 minutes.

32. The process according to claim 31 wherein the heating is carried out from between about 5 and about 60 minutes.

33. The process according to claim 32 wherein the heating is carried out from between about 15 and about 40 minutes.

34. The process according to claim 22 wherein the rapid cooling is at least about 2° C. per minute.

35. The process according to claim 34 wherein the rapid cooling is between about 3° C. to about 5° C. per minute.

36. The process according to claim 22 wherein the food is cooled to about 10° C. or less.

37. The process according to claim 22 wherein the cooling is carried out using a combination of cooling water at ambient temperatures, chilled water and/or liquid nitrogen or carbon-dioxide which are used as direct contact refrigerants.

38. The process according to claim 37 wherein the rapid cooling step substantially prevents both mesophilic and thermophilic microbial spores from germinating.

39. The process according to claim 22 carried out using over- or positive pressure in a vessel or retort.

40. A food product having an extended refrigerated shelf life of at least about six months produced by the process according to claim 22.

41. A process for producing a processed refrigerated food product comprising:
placing food material in a container;
hermetically sealing the container prior to heating to inactivate undesirable microorganisms;
heating the food material in the sealed container at a temperature to achieve a minimum Fₚ value equivalent to about 20 minutes at about 90° C. to inactivate undesirable microorganisms likely to be present in the food material; and
rapidly cooling the heated food to substantially prevent germination of undesirable microbial spores likely to be present in the food material to obtain a processed food product having a refrigerated shelf life of at least about six months.
